(19) United States
(12) Patent Application Publication
(10) Pub. No.: US 2014/0255081 A1
(43) Pub. Date: Sep. 11, 2014

(54) Profile Connector

(71) Applicants: Arne LIEBSCHER, Herdecke (DE); Andreas Finke, Gevelsberg (DE); Andreas Baruth, Bad Salzuflen (DE)

(72) Inventors: Arne LIEBSCHER, Herdecke (DE); Andreas Finke, Gevelsberg (DE); Andreas Baruth, Bad Salzuflen (DE)

(73) Assignee: Dorma GmbH + Co. KG

(21) Appl. No.: 14/201,035

(22) Filed: Mar. 7, 2014

(30) Foreign Application Priority Data
Mar. 8, 2013 (DE) 10 2013 102 339.8
Jan. 22, 2014 (DE) 10 2014 100 688.7

(51) Int. Cl. F16B 7/04

(52) U.S. Cl. CPC F16B 7/0446
USPC 403/41

(57) ABSTRACT

A profile connector for the anti-torsion protection of a connection of a first frame leaf profile to a second frame leaf profile in a butt-joint configuration includes a first supporting portion for a torsion-resistant support at the first frame leaf profile and a second supporting portion for the torsion-resistant support at the second frame leaf profile.

### BACKGROUND OF THE INVENTION

1. Field of the Invention

The present invention relates to a profile connector for a torsion-resistant connection of a first frame leaf profile to a second frame leaf profile in a butt-joint configuration as well as to a profile frame with at least one first and one second frame leaf profiles, which are connected to each other in a butt-joint configuration.

2. Description of the Related Art

As is generally known, profile frames, e.g. for the reception of glass panes, are assembled from individual frame leaf profiles. Usually such frame leaf profiles may be manufactured in an extrusion process or in a continuous casting process, such that they have a substantially straight extension. In order to be able to completely surround a filling in the shape of a glass pane with a profile frame, accordingly at the upper side and at the lower side, respectively, one horizontal frame leaf profile is needed and at both sides on the left and on the right, respectively, one vertical frame leaf profile is needed. Once framed with the four frame leaf profiles, the individual frame leaf profiles need to be connected to each other at the corners. For prior art profile frames the connection is realized in a mitered configuration and accordingly by making a 45° cut. In prior art profile frames, it is likewise known to realize a connection in a butt-joint configuration at the lower end thereof.

In prior art profile frames, the connections are essentially and exclusively fixed by bonding. Prior to the bonding, preparation steps must take place. If the connection is mitered, the two frame leaf profiles need to present the corresponding miter angle and need to be cut correspondingly. In case of a connection to each other in a butt-joint configuration, a corresponding locating strip must be removed from the respective one horizontal profile by milling in order to make room for the reception of the butt-joint connection of the vertical frame leaf profile. Both cases thus require additional expense in the form of machining. Furthermore, in particular for a mitered connection, there will be cutting scrap, which is considered as waste. Last but not least the step of bonding is relatively complicated and needs to be performed, e.g., by special tools in the shape of collet chucks. Curing the adhesive is likewise time-consuming, resulting in delay in the overall manufacturing. A completely different fastening method, e.g., by screw connections, is not possible with the prior art profile frames, because the desired strength of the connection between the neighboring frame leaf profiles cannot be obtained or can only be obtained at a very high constructional expense.

### SUMMARY OF THE INVENTION

Therefore, it is an object of the present invention to overcome the above described disadvantages, at least partially. It is in particular the object of the present invention to provide assembling of a profile frame in an inexpensive and simple manner.

In one aspect of the present invention, the above mentioned problem may be solved by a profile connector as well as by a profile frame. Further features and details of the invention are likewise apparent from the description and the drawings. In this case, features and details, described in conjunction with the inventive profile connector, are obviously also valid in conjunction with the inventive profile frame and respectively vice versa, such that mutual reference is made, respectively can be made with respect to the disclosure of individual aspects of the invention.

In one aspect of the invention, an inventive profile connector is configured for protection against torsion of a connection of a first frame leaf profile to a second frame leaf profile in a butt-joint configuration. For this purpose, the profile connector according to the aspect of the present invention has a first supporting portion for a torsion-resistant support at the first frame leaf profile. Furthermore, the inventive profile connector has a second supporting portion for the torsion-resistant support at the second frame leaf profile.

One aspect of the present invention thus provides, by a profile connector, an additional component when compared to prior art frame profiles. The additional component focuses on the function of the anti-torsion protection. Thus, the pure connection, namely the mechanical fastening of two adjoining frame leaf profiles, can be realized independently of the functionality of the anti-torsion protection. Thus, in case of a bonded connection, a screw connection, a latching connection, a riveted connection or any other form of connection between the two neighboring frame leaf profiles, an anti-torsion protection does not need to be addressed. Namely according to the inventive aspect, the anti-torsion protection is now provided by the profile connector. This circumstance allows that, by using the profile connector, considerably simpler, less expensive and even more so easier options for assembling are provided in order to connect the two neighboring frame leaf profiles to each other. In particular frame leaf profiles can be interconnected in this manner, which have a connection in a butt-joint configuration.

In comparison to prior art profile frames, in particular the complicated step of the mitered connection can be foregone. The steps of gluing and bracing with complicated collect chucks linked thereto can be likewise omitted. Thanks to the simplification of a butt-joint connection, moreover a machining process, respectively the cutting scrap when realizing the mitered connection, can be omitted. The manufacturing process is therefore made considerably more efficient.

According to an aspect of the present invention, a frame leaf profile is understood to be, in particular, a hollow profile. A frame leaf profile is, in particular, a profile, configured for a lateral reception of a filling of a profile frame. Such a filling may be, for example, a glass pane. However, other fillings, which can be retained by the appropriate frame leaf profile, are conceivable. Thus, in one aspect, a frame leaf profile includes in particular, at least one reception groove or at least one reception surface, which serves as the reception of a filling for the profile frame.

A supporting portion, according to an aspect of the present invention, is to be understood as a surface portion of the profile connector, which allows for a torsion-resistant support at respectively one frame leaf profile. Thus, in one aspect, the supporting portion is, in particular, a locating surface, which provides for contact between the profile connector and a frame leaf profile. The locating surface is aligned such that an anti-torsion protection is realized between the profile connector and the respective frame leaf profile.

The double anti-torsion protection, namely the configuration of at least two supporting portions, allows for a double anti-torsion protection indirectly by the profile connector. To the one side, the profile connector props itself up against the first frame leaf profile in a torsion-resistant manner, whereas to the other side, the profile connector props itself up against the second frame leaf profile in a torsion-resistant manner. In total, the two adjoining frame leaf profiles are supported against each other in a torsion-resistant manner indirectly by the profile connector.

It should be noted that the profile connector does not necessarily realize the actual connection as well of the two frame leaf profiles, e.g., although this is possible. Likewise separate fasteners, in the shape of, e.g., screws, may be provided in order to realize the actual fastening of the butt-joint connection of the two frame leaf profiles. Also a combination of fasteners and profile connectors, which likewise serve fastening purposes, is conceivable within the framework of the present invention.

It is not only the manufacturing process that becomes less expensive and simpler on account of the inventive profile connector; the location of manufacture also can be freely chosen. Thus, with an inventive profile connector, it is conceivable to perform the actual assembly of the profile frame only on site, namely at the location of use of the profile frame. This circumstance allows for providing exact profile frames dimensioned accurately to the millimeter and without incurring high and costly expenses in manufacturing. While previously only standard sizes of the current profile frames could be manufactured in a cost-efficient manner, individual solutions can now be directly realized on the construction site and the width and/or height of the profile frame can be adapted to the millimeter. The corresponding cutting of the associated frame leaf profile is likewise done on the construction site, such that an adaptation to the millimeter with the help of the profile connector results in an assembly on the construction site.

In another aspect, the profile connectors can be configured to allow for disassembly as well. Thus, such reversible profile frames can be provided, e.g., for temporary buildings. Therefore, considerable reduction in space is achieved, in particular with regard to transporting such structural components.

According to the present invention, a butt-joint does not necessarily mean a 90° angular connection. However, an angle of approximately or essentially 90° will be preferred, because this corresponds to the usual construction type of profile frames. However, within the scope of the present invention, other angular cuts, such as for triangular windows, are connectable by a profile connector.

Another advantage of utilizing an inventive profile connector is that the total amount of different profiles can be reduced. The profile connector thus helps to reduce the complexity of the manufacturing widths of different profile cross-sections. Thus, for the most different application purposes, in particular a single frame leaf profile, or else two frame leaf profiles (vertical and horizontal), could be provided. Without limiting the wide variety of different profile frames, considerably higher cost efficiency can be achieved in manufacturing of only one or two different frame leaf profiles.

It may be advantageous in the inventive profile connector, if at least one mounting opening is provided through which a fastener is passed when establishing the connection of the two frame leaf profiles. The mounting opening may have a completely surrounding border or else may be likewise open to the side. In particular, there are even two or more mounting openings provided at the profile connector. The mounting opening serves, e.g., the purpose of allowing fasteners in the shape of screws to pass therethrough. In this case, the fastening may be realized in the mounting opening. However, it is preferred, if the fasteners essentially project freely through the mounting opening and just provide the connection between the two neighboring and adjoining frame leaf profiles. In case screws are the fasteners the mounting openings do not present any threads for engaging the threads of the screws. However, as basically a geometrical correlation is given between the fasteners and the mounting opening, the anti-torsion protection is even more reinforced. Additional protection is, in particular, provided which becomes active in case the anti-torsion protection provided by the above described support surfaces, respectively supporting portions would not be sufficient any more.

Another advantage is provided, if, in an inventive profile connector, at least one of the supporting portions is configured to be insertable into one of the frame leaf profiles, for the defined positioning of the profile connector with regard to the frame leaf profiles. In this case at least one of the frame leaf profiles is configured as a hollow profile. This weight reduction results in a hollow space, respectively in an inner compartment in this frame leaf profile configured as a hollow profile. Now, at least one of the supporting portions can be introduced into this hollow space, respectively into the inner compartment. Thereby, a particularly large locating surface can be provided as the supporting portion. Moreover, by inserting, e.g., pressure bonding or even a material shearing off can take place at the supporting portion. The pressure bonding and the thereto associated bracing for realizing the anti-torsion protection prevents even the smallest play between the profile connector and the respective frame leaf profile. The anti-torsion protection is thereby considerably improved.

In an advantageous aspect, in an inventive profile connector, at least one of the two supporting portions is configured to be oversized with regard to the constructional space at the installation location of the associated frame leaf profile. Oversized is to be understood to mean that at least one geometrical direction of extension exceeds the corresponding geometrical extension direction of the corresponding supporting surface of the frame leaf profile. When positioning the profile connector at the corresponding mounting position, the oversized portion results in deforming, e.g., the oversized portion. The deformation may occur in an elastic or even plastic manner. An elastic deformation results in an elastic counter-force, such that, in the installed condition, while the elastic deformation persists, the elastic restoring force represents the clamping force for the anti-torsion protection. Plastic deformations are likewise conceivable such that a press-fit system is provided. If the profile connector in a plastic deformation is for example made from metal, the plastic deformation may result in an additional hardening, e.g., in the shape of strain hardening. The oversized portion may be likewise sheared off by corresponding configurations of the frame leaf profile and/or by the supporting portion, such that the described fitting respectively the corresponding press-fit seat is likewise configured.

In an advantageous aspect according to the preceding section, the oversized portion is configured by at least one structural rib. A portion, which protrudes at least partially beyond a base surface of the profile connector, is to be understood as the structural rib. A supporting portion, which is configured at least in portions as the structural rib, thus forms a defined difference between the basic body of the profile connector and the corresponding supporting portions. The supporting portions may be defined and manufactured accordingly thereto such that for the remaining portions, namely in particular for the basic body of the profile connector, a simpler manufacturing characteristic is applicable. A more precise tolerance may be, in particular, taken as the base for the manufacturing, whereas the basic body of the profile connector is manufactured in a simpler manner and with larger tolerance variations.

In an advantageous aspect, in the inventive profile connector, at least one of the supporting portions is configured with an introduction area, which simplifies the introduction into the supporting position at the respective frame leaf profile. In this case, an introduction is in particular configured in the shape of a ramp, respectively in the shape of a conical portion. In this case, the introduction area is disposed at least at one end of the profile portion with regard to the respective introduction direction. During introduction into the desired installation situation, namely, in particular, into the inside of a hollow profile of a frame leaf profile, the introduction may be done in an easier manner. In particular, the first step of introducing may be realized essentially via the introduction area such that the introduction area does not yet serve for supporting and thus as the anti-torsion protection. The introduction area rather brings the profile connector into a position, such that, in a second mounting step, the actual abutting of the supporting surface against the frame leaf profile occurs. In this manner, the desired installation position of the profile connector can be achieved in a particularly reliable and moreover in a predefined manner.

In another aspect, a profile frame having at least one first frame leaf profile and at least one second frame leaf profile, are connected in a butt-joint relationship to each other. In one aspect, a profile frame is formed such that at least one profile connector, in particular according to the present invention, is provided for the anti-torsion protection of the connection. For this purpose, the profile connector props itself up against the first frame leaf profile with a first supporting portion and props itself up against the second frame leaf profile in a torsion-resistant manner with a second supporting portion. An inventive profile frame has the same advantages as those explained in detail with regard to an inventive profile connector.

The inventive profile frame may be further developed such that at least one of the two frame leaf profiles is configured as a hollow profile and the associated supporting portion extends at least partially into the inside of the hollow profile. As already explained with reference to the profile connector, a particularly advantageous torsion-resistant support can be achieved in this manner. Moreover, the required constructional space of the profile connector is reduced to a minimum. In particular no additional constructional space is required between the two frame leaf profiles. The two frame leaf profiles can rather continue to abut against each other, because the profile connector extends at least in portions into the inside of a corresponding hollow profile.

Moreover the profile connector is not visible from the outside such that a high visual standard is guaranteed.

In another advantageous aspect, in the inventive profile frame, at least one locating strip is provided to locate a filling of the profile frame at least at one frame leaf profile. The locating strip is in particular inserted and/or introduced into a guiding groove of the frame leaf profile. Accordingly, the locating strips are separate constructional components with regard to the frame leaf profiles. The locating strips are preferably configured in an identical manner for the vertical frame leaf profiles and the horizontal frame leaf profiles. In comparison to prior art profile frames, where, in case of butt-joint connections, the locating strips needed to be milled off in the area of the butt-joint connection, in this case again, the locating strips can be cut accurately to the millimeter and subsequently introduced into the guiding groove. The cut allows for manufacturing the locating strip as a separate constructional component in a continuous casting process or an extrusion process such that the complexity is likewise reduced while simultaneously the milling step is avoided. In this case, the locating strip serves in particular as a locating device at a glass pane, i.e., the filling. Obviously, the locating strip may include sealing elements in order to achieve a sealing of the filling. Separate sealing elements in separate guides of the frame leaf profile are likewise conceivable within the scope of the present invention.

In another aspect, the profile frame is advantageously configured such that at least one fastener, in particular at least one reversible fastener, is provided for fastening the two frame leaf profiles to each other. The fasteners are, e.g., screws or rivets. However, screws are preferred as reversible fasteners, because disassembling the profile frame is likewise possible in this way. The fasteners may be configured in the shape of screws, e.g., self-cutting screws, such that corresponding screw channels are provided in at least one of the two frame leaf profiles. In case of self-cutting screws as the fasteners, the screw channels do not have to be provided with a thread, such that the frame leaf profiles can still be manufactured in a continuous casting process, respectively in an extrusion process. In order to make sure that a very simple mounting can be achieved, the mounting openings of the profile connectors are preferably configured to be identical for all corner connections. Thus, in case of two or more fasteners for each profile connector, a uniform drilling template can be utilized for each mounting situation.

According to another aspect of the present invention, a mounting method is provided for manufacturing a profile frame according to the present invention including a profile connector according to the present invention. Therefore, a mounting method includes the same advantages as the advantages explained in detail with regard to an inventive profile frame and the advantages that have been explained with regard to the inventive profile connector. Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

Further advantages, details and features of the invention will result from the following description, in which exemplary embodiments of the invention are described in detail, reference being made to the drawings. In this context, the features mentioned in the claims and in the description, individually or randomly combined, may be essential to the invention.

### BRIEF DESCRIPTION OF THE DRAWINGS

In the drawings:

FIG. 1: shows a mitered connection according to the state-of-the-art;

FIG. 2: illustrates the preparation of a butt-joint connection according to the state-of-the-art;

FIG. 3: is a detailed view in an exploded illustration of an employed inventive profile connector;

FIG. 4: illustrates an embodiment of an inventive profile connector; and

FIG. 5: illustrates an embodiment of an inventive profile frame.

### DETAILED DESCRIPTION OF THE PRESENTLY PREFERRED EMBODIMENTS

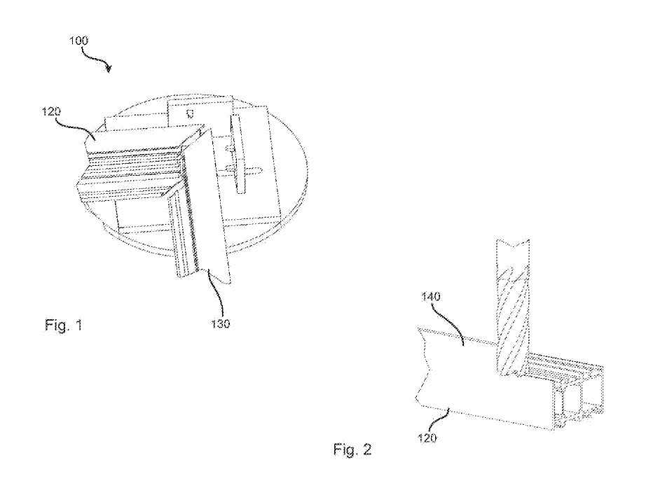

FIGS. 1 and 2 illustrate the state-of-the-art. FIG. 1 thus shows the preparation work of a mitered connection between a first frame leaf profile 120 and a second frame leaf profile 130 of a profile frame 100. For this purpose, diagrammatically, two chucking tools are illustrated, which apply the required clamping force at the corners for gluing. In this instance the high manufacturing expense is clearly discernible.

In FIG. 2, the preparation work of a butt-joint connection for prior art frame leaf profiles 120 and 130 is illustrated. In this case, locating strips 140 are part of the frame leaf profile 120 such that, for the preparation work of the abutting surfaces, this part of the locating strip 140 has to be removed with a milling head. This again requires additional expense resulting in time and cost.

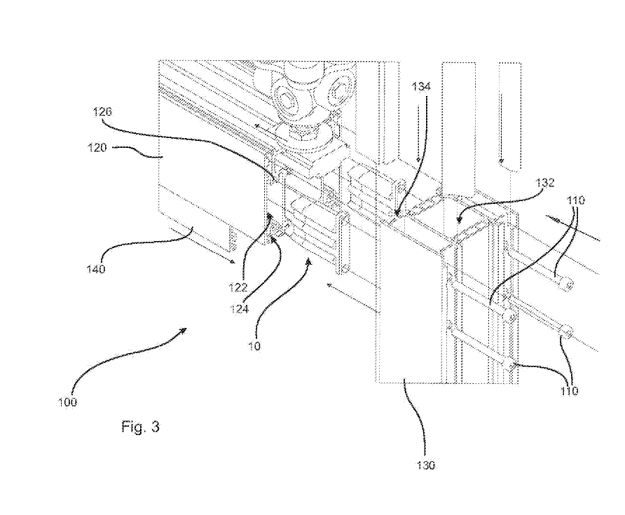

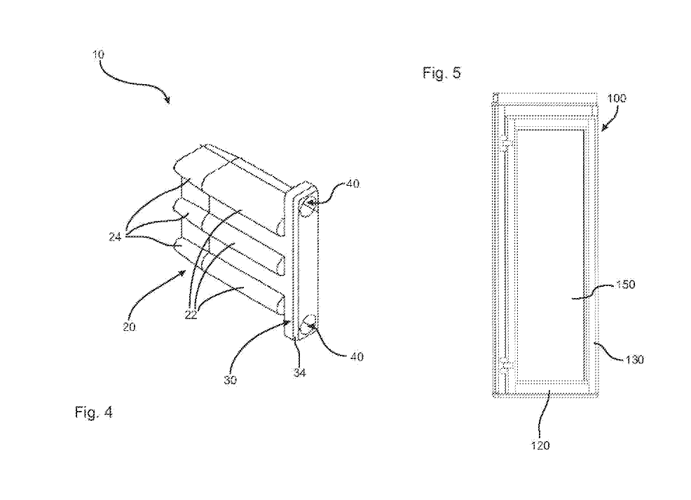

FIG. 4 diagrammatically illustrates an exemplary embodiment of an inventive profile connector 10. The connector 10 includes a hammer-shaped head, which acts as a first supporting surface 30. Moreover, the profile connector has a first supporting portion 20 extending across three structural ribs 22, which may extend (refer to FIG. 3) into the inner compartment of a frame leaf profile 120, configured in this case as a hollow profile.

FIG. 5 shows a profile frame 100, which is configured with butt-joint connections of two horizontal first frame leaf profiles 120 and two vertical second frame leaf profiles 130. In this case, a filling 150, e.g., in the shape of a glass pane, is disposed between the individual frame leaf profiles 120 and 130.

FIG. 3 shows the installation situation of an exemplary embodiment of an inventive profile connector 10. In this case, in an exploded illustration it is explained how the mounting may take place. Thus, at first the first (horizontal) frame leaf profile 120 is provided. Subsequently, cut to the same length, a locating strip 140 may be inserted into the corresponding guiding groove 124. Subsequently, the profile connector 10, as already explained in conjunction with FIG. 4, including the structural ribs 22 as the first supporting portion 20, is inserted into the inside 122 of the first frame leaf profile 120. In order to simplify the insertion, an introduction area 24, which improves and facilitates the proper insertion, is provided at the supporting portion 20. Subsequently, the second (vertical) frame leaf profile 130 is put in place and reaches in this case the torsion-resistant supporting contact with the second supporting portion 30. In order to be able to reach this contact, chamfered surfaces, serving as the introduction areas 34, are provided at the profile connector 10. Finally, the fasteners 110, in the shape of screws, realize the final fastening. The screws, as the fasteners 110, are preferably self-cutting screws, which engage into a corresponding screw channel 126 of the first frame leaf profile 120 and cut a thread into the latter. Finally, the fastening of the two frame leaf profiles 120 and 130 to each other can be provided in a defined manner via the fasteners 110. An anti-torsion protection is illustrated independently of the fasteners 110 by the profile connector 10.

The above explanation of the embodiments describes the present invention exclusively based on examples. Individual features of the embodiments, as long as technically reasonable, can be combined independently of each other without leaving the scope of the present invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A profile connector (10) for the anti-torsion protection of a connection of a first frame leaf profile (120) to a second frame leaf profile (130) in a butt-joint configuration, comprising:
a first supporting portion (20) configured to provide a torsion-resistant support at the first frame leaf profile (120); and
a second supporting portion (30) configured to provide the torsion-resistant support at the second frame leaf profile (130).

2. The profile connector (10) according to claim 1, wherein the profile connector (10) defines at least one mounting opening (40) configured to permit at least one fastener (110) to be guided therethrough when establishing the connection of the first frame leaf profile (120) to the second frame leaf profile (130).

3. The profile connector (10) according to claim 1, wherein at least one of the first and second supporting portions (20, 30) is configured to be insertable into one of the frame leaf profiles (120, 130) for a defined positioning of the profile connector (10).

4. The profile connector (10) according to claim 1, wherein at least one of the first and second supporting portions (20, 30) is configured as an oversized portion with regard to the constructional space at the installation location of the associated first or second frame leaf profile (120, 130).

5. The profile connector (10) according to claim 4, wherein the oversized portion comprises at least one structural rib (22).

6. The profile connector (10) according to claim 1, wherein at least one of the first and second supporting portions (20, 30) comprises an introduction area (24, 34) configured to facilitate the introduction of the profile connector (10) into a supporting position at a respective one of first and second frame leaf profiles (120, 130).

7. A profile frame (100) comprising:
at least one first frame leaf profile (120);
at least one second frame leaf profile (130), connected to the at least one first frame leaf profile (120) in a butt-joint configuration; and
at least one profile connector (10) configured to provide anti-torsion protection of the connection between the first frame leaf profile (120) and the second frame leaf profile (130), the at least one profile connector (10) having:
a first supporting portion (20) configured to provide a torsion-resistant support at the first frame leaf profile (120), and
a second supporting portion (30) configured to provide the torsion-resistant support at the second frame leaf profile (130).

8. The profile frame (100) according to claim 7, wherein at least one of the first and second frame leaf profiles (120, 130) is configured to have a hollow profile and an associated one of the first and second supporting portions (20, 30) extends at least partially into an inside (122, 132) of said hollow profile.

9. The profile frame (100) according to claim 8, further comprising at least one locating strip (140) configured to:
(a) locate a filling (150) of the profile frame (100) against at least one of the first and second frame leaf profiles (120, 130), and (b) be inserted and/or introduced into a guiding groove (124, 134) of the frame leaf profile (120, 130).

10. The profile frame (100) according to claim 9, further comprising at least one fastener (110), configured to fasten the first and second frame leaf profiles (120, 130) to each other.

11. The profile frame (100) according to claim 10, wherein the at least one fastener (110) comprises at least one reversible fastener (110).
